(19) United States
(12) Patent Application Publication
(10) Pub. No.: US 2020/0399108 A1
(43) Pub. Date: Dec. 24, 2020

(54) REMOVABLE RESERVOIR WATER DISPENSING SYSTEM THAT MAINTAINS A PRE-SET DISPENSING TEMPERATURE

(71) Applicant: Kenneth A NICOLLE, VICTORIA (CA)

(72) Inventor: Kenneth A NICOLLE, VICTORIA (CA)

(21) Appl. No.: 17/013,543

(22) Filed: Sep. 5, 2020

Related U.S. Application Data
(63) Continuation of application No. PCT/CA2019/050273, filed on Mar. 6, 2019.

(30) Foreign Application Priority Data
Mar. 9, 2018 (CA) 2997886

(51) Int. Cl. B67D 1/00; B67D 1/08

(52) U.S. Cl. CPC B67D 1/0004; B67D 1/0857; B67D 2210/00099; B67D 2210/00047; B67D 1/0895

(57) ABSTRACT

A removable reservoir water dispensing system which includes a water dispenser body with a built-in water reservoir and a coupling for connecting a removable water reservoir to the built-in reservoir. A drainage pipe, through which water is drained from the built-in reservoir, extends through a bottom of the built-in reservoir. The drainage pipe has a first end and a second end. The second end is connected to a dispensing faucet on the water dispenser body. The first end extends vertically into the built-in water reservoir for at least one third of a height of the built-in water reservoir. Water in the built-in water reservoir, positioned below the first end of the drainage pipe, is unable to pass through the drainage pipe to the dispensing faucet and is always resident in the built-in water reservoir at a pre-set dispensing temperature.

### FIELD

There is described a removable reservoir water dispensing system that maintains a pre-set dispensing temperature, notwithstanding reservoir replacement.

### BACKGROUND

Every water dispensing system has a built-in water reservoir. The built-in water reservoir is encircled by coils which are used to heat or cool water in the built-in reservoir. A drainage pipe extends from the bottom of the built-in reservoir to a dispensing faucet.

Some water dispensing systems are connected to a water service for a building, which provides the built-in reservoir with an endless supply of water. As water is withdrawn from the built-in reservoir, it is replaced with water from the water service.

The built-in water reservoir in those water dispensing systems that are not connected to a water service, is supplemented by a removable reservoir. The most common form of removable reservoir in use today is an inverted water bottle. It will be appreciate that there are water dispensing systems that use water bottles that are not inverted as removable reservoirs. It will also be appreciated that the removable reservoirs can be in other forms such as bags and bladders. Generally, some form of removable reservoir is required, as the built-in water reservoir has limited capacity.

With water dispensing systems having some form of removable reservoir, as water is drawn from the built-in water reservoir, it is replaced with water from the removable reservoir. Eventually, the removable reservoir becomes empty and, as water is drawn from the built-in water reservoir, it is no longer replaced with water from the removable reservoir. Water may still be drawn from the built-in water reservoir, until the built-in water reservoir also becomes empty and ceases to dispense water.

When the built-in water reservoir ceases to dispense water, the empty removable reservoir is replaced by a full removable reservoir in order to make the water dispensing system functional again. As soon as the full removable reservoir is put in place, the built-in water reservoir is rapidly refilled. Although water can immediately be drawn from the water dispensing system, it takes time for the coils to heat or cool the water to a desired dispensing temperature. The lag-time required to achieve the desired dispensing temperature can be between thirty and ninety minutes, depending upon the physical size of the built-in water reservoir and the temperature of the water received from the full removable reservoir. It is this lag-time in achieving the desired dispensing temperature that the present invention is intended to address.

### SUMMARY

There is provided a removable reservoir water dispensing system which includes a water dispenser body with a built-in water reservoir housed in the water dispenser body. The built-in water reservoir has a bottom and sidewalls. A coupling is provided for connecting a removable water reservoir to the built-in reservoir, such that water is supplied by the removable water reservoir through a water supply inlet to the built-in reservoir. Coils, which provide heating or cooling, encircle the sidewalls of the built-in water reservoir. A drainage pipe, through which water is drained from the built-in reservoir, extends through the bottom of the built-in reservoir. The drainage pipe has a first end and a second end. The second end is connected to a dispensing faucet on the water dispenser body. The first end extends vertically into the built-in water reservoir for at least one third of a height of the built-in water reservoir. Water in the built-in water reservoir, positioned below the first end of the drainage pipe, is unable to pass through the drainage pipe to the dispensing faucet and is always resident in the built-in water reservoir at a pre-set dispensing temperature.

With the removable reservoir water dispensing system described above, when the level of the water in the built-in water reservoir falls below the first end of the drainage pipe, the water dispensing system ceases to function. Water in the built-in water reservoir, positioned below the first end of the drainage pipe, is unable to pass through the drainage pipe to the dispensing faucet and is always resident in the built-in water reservoir at a pre-set dispensing temperature. As a result, when an empty removable reservoir is replaced with a fill removable reservoir, there is already approximately one third of the built-in water reservoir at the desired dispensing temperature.

Depending upon the position of the water supply inlet, water received from the removable water reservoir that has not, as yet, reached the desired dispensing temperature may “short cut” through the first end of the drainage pipe. It is, therefore, preferred that the water supply inlet from the removable water reservoir terminate in proximity with the bottom of the built-in water reservoir. This forces the water newly received from the removable water reservoir to migrate up from the bottom before reaching the first end of the drainage pipe which leads to the dispensing faucet.

This feature of maintaining a pre-set dispensing temperature functions even better when a larger proportion of the water is always resident in the built-in water reservoir at a pre-set dispensing temperature. It is, therefore, preferred that the first end of the drainage pipe extend vertically into the built-in water reservoir for at least one half of the height of the built-in water reservoir.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view in section of removable reservoir water dispensing system.

### DETAILED DESCRIPTION

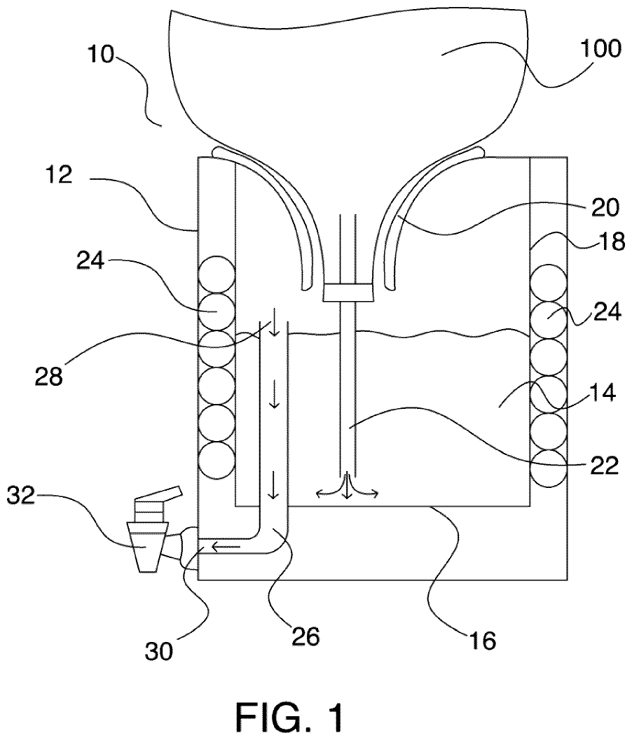

A removable reservoir water dispensing system generally identified by reference numeral 10, will now be described with reference to FIG. 1.

### Structure and Relationship of Parts:

Referring to FIG. 1, removable reservoir water dispensing system 10 includes a water dispenser body 12 with a built-in water reservoir 14 housed in water dispenser body 12. Built-in water reservoir 14 has a bottom 16 and sidewalls 18. A coupling 20 is provided for connecting a removable water reservoir 100 to built-in reservoir 14, such that water is supplied by removable water reservoir 100 through a water supply inlet 22 to built-in reservoir 14. Coils 24, which provide heating or cooling, encircle sidewalls 18 of built-in water reservoir 14.

A drainage pipe 26, through which water is drained from built-in reservoir 14, extends through bottom 16 of built-in reservoir 14. Drainage pipe 26 has a first end 28 and a second end 30. Second end 30 is connected to a dispensing faucet 32 on water dispenser body 12. First end 28 extends vertically into built-in water reservoir 14 for at least one third and, preferably at least one half of a height of built-in water reservoir 14.

### Operation:

Referring to FIG. 1, water in built-in water reservoir 14 that is positioned below first end 28 of drainage pipe 26, is unable to pass through drainage pipe 26 to dispensing faucet 32. As a result, such water is always resident in built-in water reservoir 14 at a pre-set dispensing temperature.

When removable reservoir 100 is empty, water will continue to be dispensed from water dispensing system 10 until the level of water in built-in water reservoir 14 falls below first end 28 of drainage pipe 26. When water is no longer able to enter first end 28 of drainage pipe 26, water dispensing system 10 ceases to function. However, although water dispensing system 10 ceases to function, it is not empty. Water in built-in water reservoir 14, positioned below first end 28 of drainage pipe 26 remains resident in built-in water reservoir 14 at a pre-set dispensing temperature.

When an empty removable reservoir 100 is replaced with a full removable reservoir, there is already approximately one third, one half or more of the water in built-in water reservoir 14 at the desired dispensing temperature (depending upon where in built-in water reservoir 14 first end 28 of drainage pipe 26 has been located).

In order to avoid having water received from the removable water reservoir that has not, as yet, reached the desired dispensing temperature passing through first end 28 of drainage pipe 26; it is preferred that water supply inlet 22 from removable water reservoir 100 terminate in proximity with bottom 16 of built-in water reservoir 14. This forces the water newly received from removable water reservoir 100 to migrate up from bottom 16 before reaching first end 28 of drainage pipe 26, giving the newly added water time to cool.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. A removable reservoir water dispensing system, comprising:
a water dispenser body;
a built-in water reservoir housed in the water dispenser body, the built-in water reservoir having a bottom and sidewalls;
a coupling for connecting a removable water reservoir to the built-in reservoir, such that water is supplied by the removable water reservoir through a water supply inlet to the built-in reservoir;
coils which provide heating or cooling encircling the sidewalls of the built-in water reservoir; and
a drainage pipe through which water is drained from the built-in reservoir extending through the bottom of the built-in reservoir, the drainage pipe having a first end and a second end, the second end being connected to a dispensing faucet on the water dispenser body, the first end of the drainage pipe extending vertically into the built-in water reservoir for at least one third of a height of the built-in water reservoir, such that water in the built-in water reservoir positioned below the first end of the drainage pipe is unable to pass through the drainage pipe to the dispensing faucet and is always resident in the built-in water reservoir at a pre-set dispensing temperature.

2. The removable reservoir water dispensing system of claim 1, wherein the first end of the drainage pipe extends vertically into the built-in water reservoir for at least one half of the height of the built-in water reservoir.

3. The removable reservoir water dispensing system of claim 2, wherein the water supply inlet from the removable water reservoir terminates in proximity with the bottom of the built-in water reservoir.
